(19) United States
(12) Patent Application Publication
(10) Pub. No.: US 2018/0188842 A1
(43) Pub. Date: Jul. 5, 2018

(54) METHOD AND DEVICE FOR OPERATING CAPACITIVE TOUCH PANEL

(71) Applicant: Industry-University Cooperation Foundation Hanyang University, Seoul (KR)

(72) Inventor: Oh-Kyong KWON, Seoul (KR)

(73) Assignee: Industry-University Cooperation Foundation Hanyang University, Seoul (KR)

(21) Appl. No.: 15/324,537

(22) PCT Filed: Jul. 7, 2015
(86) PCT No.: PCT/KR2015/007003

§ 371 Date: Jan. 6, 2017

(30) Foreign Application Priority Data
Jul. 8, 2014 (KR) 10-2014-0085397

(51) Int. Cl. G06F 3/044; G09G 3/20

(52) U.S. Cl. CPC G06F 3/044; G06F 2203/04111; G06F 2203/04101; G09G 3/20

(57) ABSTRACT

In the touch panel device and the operating method for the same according to the present invention, an entire scan is divided into a first scan and a second scan for determining a touch position. In the first scan, a plurality of transmission electrodes are configured into groups, and a signal is applied sequentially or simultaneously such that a first analysis position is determined. In the second scan, since a signal is sequentially or simultaneously applied only to the first analysis position, a plurality of sampling durations can sufficiently be provided such that a second analysis position, which is the exact touch position, can be determined.

### TECHNICAL FIELD

The present invention relates to a method and a device for operating a capacitive touch panel and, more particularly, to a compressed sensing method in which a second analysis position is determined by determining a first analysis position through a first scan and performing a second scan in which a signal is applied only to the first analysis position determined through the first scan.

### BACKGROUND ART

Personal computers, mobile communications devices, and other personal information processing devices, etc. each utilize various input devices, such as a keyboard, mouse, digitizer, etc. for user interfacing. With expanding mobile communications device development, because it is difficult to make a complete product with input devices such as the keyboard and mouse, there is an ever-increasing need for input devices which are simpler, can reduce occurrence of malfunction, and are portable. Responding to such a need, a touch panel is proposed in which information is input by a user directly by touching a screen with a finger or a pen.

Touch panels have been and are currently being applied to various information processing devices, due to advantages of simplicity, having few malfunctions, providing excellent portability due to text input being possible without a separate input device, and ease with which a user can learn the method of use.

Touch panels are classified into a few main types according to the method of sensing. In the resistive type, metal electrodes are formed at an upper or lower plate and, with an applied DC voltage, a touch position is determined using voltage level that depends on resistance. In the capacitive type, an equipotential state is formed in a conductive film, and a touch position is sensed by sensing a position at which a voltage change has occurred between upper and lower plates due to a touch. In the electromagnetic type, an LC value induced by touching operation between an electric pen and a conductive film is read for sensing a touch position.

FIG. 1 is a diagram of an electrode structure of a typical touch panel for explaining a method of operation of a touch panel according to a conventional art.

Referring to FIG. 1, a touch sensor 100 is formed with a plurality of transmission electrodes 101, 102, 103 perpendicularly crossing a plurality of receiving electrodes 111, 112, 113. The touch sensor 100 configured as such senses coordinates corresponding to a touched portion using a capacitive change generated at a crossing between a transmission electrode and a receiving electrode due to a touch. Here, the capacitive change is detected by detecting a transmission electrode and a receiving electrode whose voltage level has changed due to the capacitive change.

There are two methods of operation for such a touch panel. The first is the scan driving method in which a signal is sequentially applied to each of a plurality of transmission electrodes. The second is the multi-line selection driving method in which a signal is simultaneously applied to a plurality of transmission electrodes.

In the scan driving method, a signal is sequentially applied to a plurality of transmission electrodes 101, 102, 103 during an entire scan. Each voltage level of the plurality of transmission electrodes 101, 102, 103 is sequentially determined for detecting a transmission electrode with a changed voltage level, among the transmission electrodes 101, 102, 103. Then, among the plurality of receiving electrodes 111, 112, 113, a receiving electrode with a changed voltage level is detected by sequentially determining the voltage level of each of the receiving electrodes 111, 112, 113. Then, coordinates are deduced by combining the position of the detected transmission electrode and receiving electrode, and the deduced coordinates correspond to the capacitive change corresponding to the touched portion.

In the multi-line selection driving method, a signal is simultaneously applied to a plurality of transmission electrodes 101, 102, 103 during an entire scan. Among the plurality of transmission electrodes 101, 102, 103, a transmission electrode with a changed voltage level is detected, and a receiving electrode with a changed voltage level is detected among the plurality of receiving electrodes by determining voltage levels of the plurality of receiving electrodes 111, 112, 113. Then, coordinates are deduced by combining the positions of the detected transmission electrode and receiving electrode, and the deduced coordinates correspond to the capacitive change corresponding to the touched position.

However, in the scan driving method, with increasing resolution of the capacitive touch panel, there may be a limitation imposed on driving duration, and in the multi-line selection driving method, there is a disadvantage of increased power consumption due to having to simultaneously drive all channels.

### DISCLOSURE OF INVENTION

### Technical Problem

The present invention is for solving the above problems of the conventional technology. That is, an entire scan is divided into a first scan and a second scan for determining a touch position. In the first scan, a plurality of transmission electrodes form a group, and a signal is sequentially or simultaneously applied for determining a first analysis position. The present invention is directed to providing a compressed sensing method in which a second analysis position is determined by sequentially or simultaneously applying a signal only to the first analysis position in the second scan.

### Technical Solution

The present invention for solving the above problems provides a touch panel device including a driver for generating a transmission signal for detecting a touch action; a touch sensor having a plurality of transmission electrodes intersecting with a plurality of receiving electrodes and forming a receiving signal according to a touch action; a receiving processor for receiving the receiving signal and outputting a signal for determining a touch position; and a compressed sensing processor for determining a first analysis position by the signal inputted from the receiving processor and determining a second analysis position by applying a signal to the determined first analysis position.

### Advantageous Effects

According to the present invention, whereas duration assigned to each transmission electrode decreases with increasing number of transmission electrodes in the conventional scan driving method in which a signal is sequentially applied to all transmission electrodes, sufficient duration may be assigned to a single transmission electrode and touch position accuracy may be increased through multiple samplings, in the compressed sensing method.

Also, whereas power consumption increases with increasing number of transmission electrodes in the conventional multi-line selection driving method in which a signal is simultaneously applied to all transmission electrodes, power consumption may be decreased in the compressed sensing method according to the present invention because a first analysis position is detected and multiple samplings are performed only at the first analysis position.

Technical effects of the present invention are not limited to the effects mentioned afore, and unmentioned other technical effects may clearly be understood by a person of ordinary skill in the art from the hereinafter description.

### BRIEF DESCRIPTION OF DRAWINGS

FIG. 1 is a diagram for explaining a typical touch panel operation device for explaining a touch panel operation method according to a conventional art.

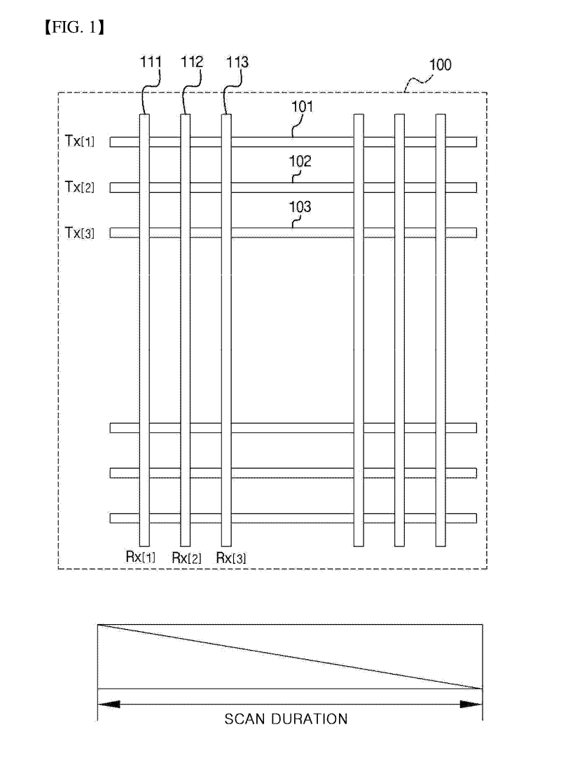

FIG. 2 is a block diagram for explaining a touch panel operation device according to an embodiment of the present invention.

FIG. 3 is a diagram for explaining a touch panel operation method according to an embodiment of the present invention.

FIG. 4 is a diagram for explaining operation duration according to an embodiment of the present invention.

### MODE OF INVENTION

While the present invention can be modified in various ways and implemented in many forms, specific embodiments are described in the drawings and explained in detail. However, there is no intent to limit the present invention to the specific disclosure, and it should be understood that the present invention includes all modifications, equivalents, and alternatives included in the idea and technical scope thereof. In describing each of the drawings, like reference numerals are used to denote like elements.

Unless otherwise defined, all terms including technical and scientific terms used herein each have the same meaning generally understood by those of ordinary knowledge in the art to which the present invention belongs. Generally used terms, such as terms defined in dictionaries, should each be interpreted by a meaning consistent with the context of related technologies and should not be interpreted by an ideal or excessively formal meaning unless clearly defined so in the present invention.

Hereinafter, exemplary embodiments of the present invention will be described in further detail with references to accompanying drawings.

### Embodiment

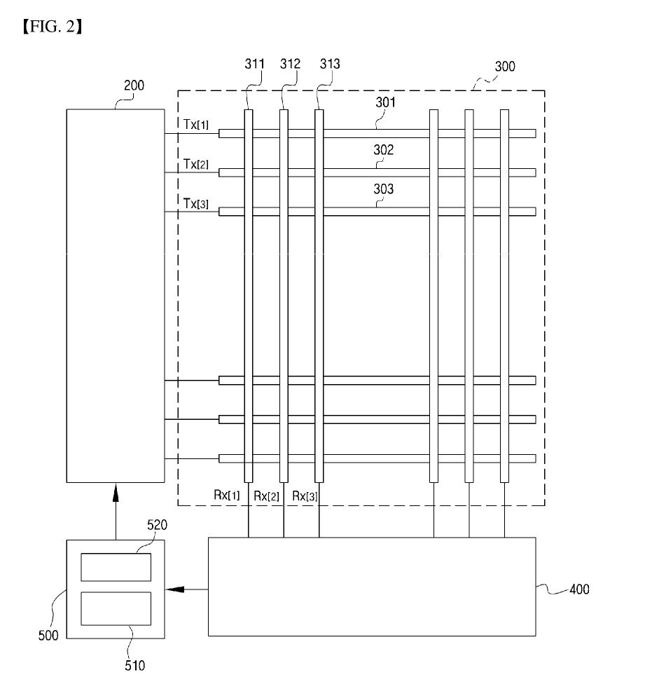

FIG. 2 is a block diagram for explaining a touch panel operation device according to an embodiment of the present invention.

Referring to FIG. 2, a touch panel device includes a driver 200, a touch sensor 300, a receiving processor 400, and a compressed sensing processor 500, and the compressed sensing processor 500 includes a discriminator 510 and a controller 520.

The driver 200 applies a transmission signal to a plurality of transmission electrodes 301, 302, 303 for discriminating a touch action detection using a compressed sensing method having a first scan (coarse sensing duration) and a second scan (fine sensing duration). During the first scan, a transmission signal is applied sequentially or simultaneously to a plurality of transmission electrodes 301, 302, 303 divided into groups, and during the second scan, a transmission signal is applied sequentially or simultaneously to a first analysis position determined during the first scan.

The touch sensor 300 has a plurality of transmission electrodes 301, 302, 303 and a plurality of receiving electrodes 311, 312, 313. Each of the transmission electrodes 301, 302, 303 is arranged perpendicularly with respect to each of the receiving electrodes 311, 312, 313, and capacitance is formed at each crossing position. Also, the transmission electrodes 301, 302, 303 are extended in a first direction and have a uniform separation distance between each other. Also, the receiving electrodes 311, 312, 313 are extended in a second direction substantially perpendicular to the first direction and have a uniform separation distance between each other. A transmission signal from the driver 200 is applied to each of the transmission electrodes 301, 302, 303, and a receiving signal is output at each of the reception electrodes 311, 312, 313.

The receiving processor 400 is input with a first detection receiving signal output from the touch sensor due to the first scan and a second detection receiving signal due to the second scan through each of the reception electrodes 311, 312, 313 and outputs a signal for determining a touch position of each thereof.

The compressed sensing processor 500 includes the discriminator 510 and the controller 520. The compressed sensing processor determines a touch position by being input with a signal output from the receiving processor 400 for determining a touch position outputs a signal to the driver 200 for performing a first scan and a second scan.

The discriminator 510 of the compressed sensing processor 500 is input with the first detection receiving signal output from the receiving processor 400 to approximately determine a touch position and determines an exact touch position by being input with the second detection receiving signal. Here, the approximate touch position estimated from the first detection receiving signal output is called a first analysis position, and the exact touch position determined from the second detection receiving signal is called a second analysis position.

The controller 520 of the compressed sensing processor 500 receives a first detection receiving signal from the discriminator 510 and determine a first analysis position and outputs a signal for applying a second detection receiving signal to the determined analysis position through the driver 200.

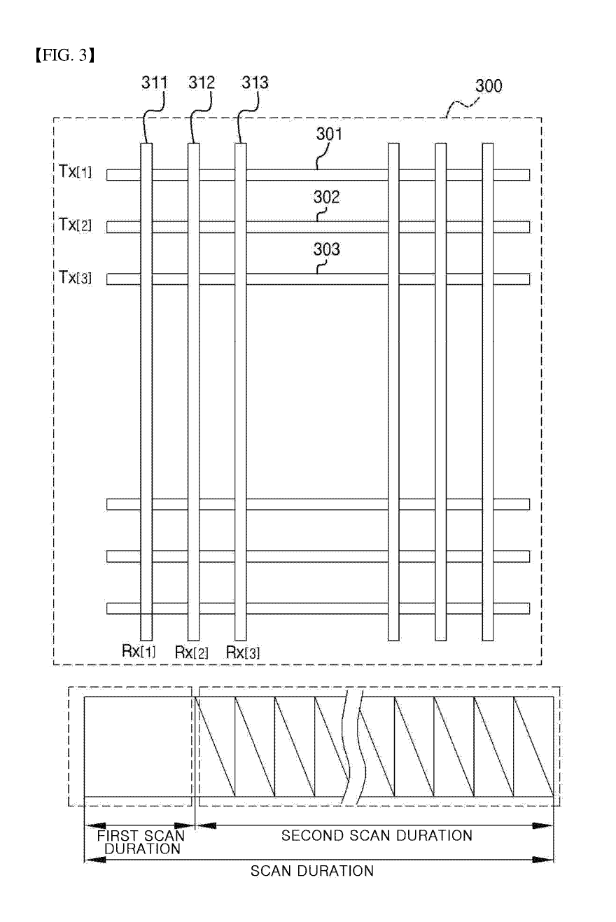

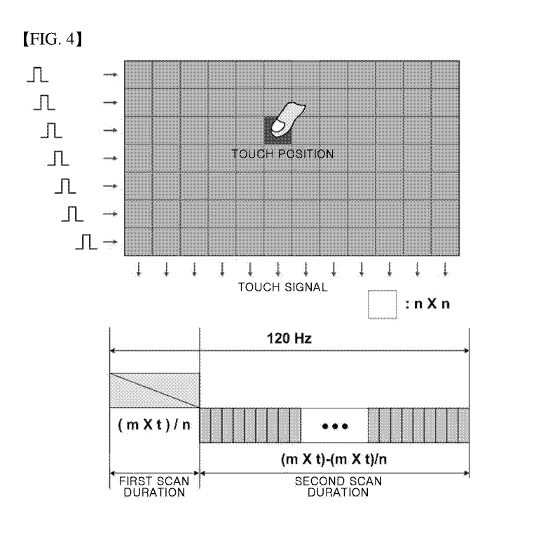

FIG. 3 is a diagram for explaining a touch panel operation method according to an embodiment of the present invention, and FIG. 4 is a diagram for explaining operation duration according to an embodiment of the present invention.

Referring to FIGS. 3 and 4, an entire scan may be divided into a first scan and a second scan for determining a touch detection position. In the first scan, the plurality of transmission electrodes 301, 302, 303 are divided into a plurality of groups and the driver 200 applies a signal for sampling to the touch sensor 300. The applying of signal from the driver 200 to the touch sensor 300 may occur sequentially or simultaneously.

When a signal is applied to the plurality of transmission electrodes 301, 302, 303 of the touch sensor 300, capacitance changed at the crossings of the plurality of transmission electrodes 301, 302, 303 and the plurality of receiving electrodes 311, 312, 313 are output through each of the receiving electrodes 311, 312, 313. The output signal output through each of the receiving electrodes 311, 312, 313 are input to the receiving processor 400, and the receiving processor 400 outputs the first detection receiving signal to the compressed sensing processor 500.

The discriminator 510 of the compressed sensing processor 500 is input with a first detection receiving signal and determines a first analysis position. When a first analysis position is determined through the discriminator 510, the controller 520 of the compressed sensing processor 500 controls the driver 200 so that a scan signal is applied only to the determined first analysis position. Here let m be the duration for scanning a plurality of transmission electrodes 301, 302, 301 and t be the duration for scanning a single transmission electrode. Assuming dividing the plurality of transmission electrodes 301, 302, 303 into n groups, of the entire scan duration next, the duration for a first scan is (m×t)/n.

When a first analysis position is determined by the discriminator 510, the first scan is finished, and a second scan is initiated through the controller 520.

During a second scan, driver 200 is controlled by the controller 520 so that signals for multiple samplings are only applied to a transmission electrode located at the first analysis position. The signal from the driver 200 applied to the touch sensor 300 may be sequentially or simultaneously applied.

Of the entire scan duration, the duration for a second scan corresponds to the entire scan duration m×t with (m×t)/n subtracted therefrom. That is, because signal is applied only to the first analysis position of the transmission electrodes during (m×t)−(m×t)/n duration, the number of multiple samplings for determining the second analysis position may be increased.

As an example, when the touch sensor 300 includes 70 transmission electrodes 301, 302, 303 and 120 receiving electrodes 311, 312, 313 and a plurality of transmission electrodes 301, 302, 303 are configured into groups of 7, in the compressed sensing method, a signal in group units of 7 is applied to have a first scan duration of 10×t, and a first analysis position is determined through the first scan. Also, a second analysis position is determined by performing sampling for a second scan duration of 60×t which is equal to an entire scan duration of 70×t with the first scan duration is subtracted therefrom.

When the plurality of transmission electrodes are configured into groups of 7, because a matrix for second scan becomes 7×7, the number of samplings of a transmission electrode while driving with a simultaneous driving method after sampling a matrix is 53×t which is a duration resulting from subtracting 7×t which is a duration for sampling one matrix when a 7×7 matrix is used during 60×t which is the second scan duration. Accordingly, the compressed sensing method has 53-fold increase in the number of samplings compared to the conventional scan drive method, and accuracy for the touch position may thus be increased.

Also, because 7×7 matrices into which a plurality of transmission electrodes divided into groups of 7 are used, the number of matrices for determining a position is decreased to 0.58% of a conventional multi-line selection method which uses 120×7 matrices, and because the number of signals applied from driver 200 to touch sensor 300 is reduced from 70 to 7, power consumption is reduced to 10%.

The operating method of the capacitive touch panel device described above according to the present invention divides an entire scan into a first scan and a second scan, determines a first analysis position by dividing a plurality of transmission electrodes 301, 302, 303 into groups and applying a signal sequentially or simultaneously thereto, and detects a second analysis position through multiple samplings by sequentially or simultaneously applying a signal to the first analysis position during the second scan.

Accordingly, whereas duration allotted for a single transmission electrode decreases with increasing number of transmission electrodes in the conventional scan driving method in which a signal is sequentially applied to all transmission electrodes, in the compressed sensing method according to the present invention, duration allotted for a single transmission electrode can sufficiently be provided, and accuracy of a touch position may be increased through multiple samplings.

Accordingly, whereas power consumption increases with increasing number of transmission electrodes in the conventional multi-line selection method in which a signal is simultaneously applied to all transmission electrodes, because a first analysis position is detected through a first scan and multiple sample is performed only on the first analysis position, power consumption is reduced in the compressed sensing method according to the present invention.

Meanwhile, embodiments of the present invention shown in the present disclosure and drawings are for enhancing understanding and are not intended to limit the scope of the present invention. It is clear to a person with ordinary knowledge in the art to which the present invention belongs that other modified embodiments based on the technical concepts of the present invention are possible besides the disclosed embodiments.

1. A touch panel device comprising:
a driver for generating a transmission signal for detecting a touch action;
a touch sensor having a plurality of transmission electrodes mutually intersecting with a plurality of receiving electrodes and forming a receiving signal according to the touch action;
a receiving processor to which the receiving signal is input and which outputs a signal for determining a touch position; and
a compressed sensing processor for determining a first analysis position using a signal input from the receiving processor and determining a second analysis position by applying a signal to the determined first analysis position.

2. The touch panel device of claim in 1, wherein the driver applies a first scan signal for determining the first analysis position and a second scan signal for determining the second analysis position.

3. The touch panel device of claim in 1, wherein the compressed sensing processor comprises:
a discriminator for discriminating a touch signal input from the receiving processor; and
a controller that generates a signal applied to the first analysis position determined by the discriminator, for discriminating the second analysis position.

4. A method of operating a touch panel device, which is a method for detecting a touch action at the touch panel device, comprising:
determining a first analysis position at which touch information is received by applying a first scan signal; and
determining a second analysis position at which touch information is received by applying a second scan signal to the first analysis position.

5. The method of claim 4, wherein the first scan signal configures a plurality of transmission electrodes into groups and apply a signal to each of the groups.

6. The method of claim 5, wherein the second scan signal applies a signal to a transmission electrode included in any one of the groups.

7. The method of claim 6, wherein the second scan signal applies a signal multiple times to the first analysis position which is any one group among the groups.

8. The method of claim 4, wherein the first analysis position includes the second analysis position and the first analysis position has a range that is larger than that of the second position.

9. The method of claim 5, wherein the applying of the first scan signal includes sequentially applying a signal to the plurality of transmission electrodes configured as groups.

10. The method of claim 9, wherein the applying of the second scan signal to the first analysis position includes sequentially applying a signal to the first analysis position.

11. The method of claim 9, wherein the applying of the second scan signal to the first analysis position includes simultaneously applying a signal to the first analysis position.

12. The method of claim 5, wherein the applying of the first scan signal includes simultaneously applying a signal to all groups of the plurality of transmission electrodes configured as groups.

13. The method of claim 12, wherein the applying of the second scan signal to the first analysis position includes sequentially applying a signal to the first analysis position.

14. The method of claim 12, wherein the applying of the second scan signal to the first analysis position includes simultaneously applying a plurality of signals to the first analysis position.

15. The method of claim 5, wherein duration of the first scan signal is equal to total scan duration divided by the number of groups.

16. The method of claim 15, wherein duration of the second scan signal is equal to total scan duration with the duration of the first scan signal subtracted therefrom.
